(19) United States
(12) Patent Application Publication
(10) Pub. No.: US 2025/0009176 A1
(43) Pub. Date: Jan. 9, 2025

(54) HEAT FLUX BARBECUE BURNER

(71) Applicant: NINGBO AGSUN PRODUCTS,INC., Cixi (CN)

(72) Inventors: Meng Lin, Cixi (CN); Meipeng Shi, Cixi (CN); Xuefei Mao, Cixi (CN); Xianghua Liu, Cixi (CN)

(21) Appl. No.: 18/892,643

(22) Filed: Sep. 23, 2024

(30) Foreign Application Priority Data
Mar. 28, 2024 (CN) 202420627775.0

(51) Int. Cl. A47J 37/07

(52) U.S. Cl. CPC A47J 37/0727

(57) ABSTRACT

The present invention discloses a heat flux barbecue burner. A housing has a drainage cavity, and a heat outlet is formed at a top of the housing. A base body is located in the drainage cavity of the housing. An ejecting tube is located in the drainage cavity of the housing and arranged above a nozzle on the base body, and a combustion port is formed at a top end of the ejecting tube. A flame projector is arranged at the combustion port of the ejecting tube. The present invention minimizes the gas flow resistance in the ejecting tube, enhancing the ejection effect.

### TECHNICAL FIELD

The present invention relates to the field of barbecue equipment, and in particular, to a heat flux barbecue burner.

### BACKGROUND

In order to heat a large-area barbecue grill, multiple burners are usually arranged below the barbecue grill for simultaneous heating or multiple ejecting tubes and nozzles are simultaneously used to increase the combustion heat by increasing the amount of ejection. As an atmospheric multi-ejecting-tube burner disclosed in Chinese Patent Document CN103216830A, the burner is connected with multiple ejecting tubes, and each ejecting tube corresponds to one nozzle, so that the multiple nozzles can simultaneously eject gas for heating. However, this structure can control only one ejecting tube alone or control multiple ejecting tubes simultaneously. It is difficult for the flame of the burner to cover the entire cavity of the barbecue grill to evenly distribute the surface temperature of the barbecue. This not only wastes energy, but also results in a poor heating effect and efficiency.

### SUMMARY

An objective of the present invention to provide a heat flux barbecue burner to solve the deficiency of the prior art.

The present invention provides a heat flux barbecue burner, including:
a housing having a drainage cavity, where a heat outlet in communication with the drainage cavity is formed at a top of the housing;
a base body located in the drainage cavity of the housing and provided with a nozzle;
an ejecting tube located in the drainage cavity of the housing and arranged above the nozzle on the base body, where an inner cavity of the ejecting tube is in a rotator structure, and a combustion port is formed at a top end of the ejecting tube and faces the heat outlet of the housing; and
a flame projector arranged at the combustion port of the ejecting tube, where an inner cavity of the flame projector includes a diffuser section proximal to the ejecting tube and a contraction section distal to the ejecting tube, the diffuser section tapers from one end proximal to the ejecting tube to the other end distal to the ejecting tube, so that a diameter of the end of the diffuser section proximal to the ejecting tube is larger than a diameter of the other end distal to the ejecting tube, and the contraction section expands from one end proximal to the diffuser section to the other end distal to the diffuser section, so that a diameter of the end of the contraction section proximal to the diffuser section is less than a diameter of the other end distal to the diffuser section.

The technical effects of the present invention are as follows: The inner cavity of the ejecting tube sequentially includes a converging section, a transition section, and a diverging section from bottom to top, making the entire inner cavity of the ejecting tube in a rocket shape. The ejecting tube is connected vertically to the base body, which minimizes the gas flow resistance in the ejecting tube, and creates an upward direct ejection effect, enhancing the ejection effect. The inner cavity of the flame projector located at the top end of the ejecting tube includes a diffuser section and a contraction section distributed from top to bottom, a throat is provided between the diffuser section and the contraction section, and inner diameters of the diffuser section and the contraction section respectively increase from the throat in the opposite direction, so that a hot gas flow coming out of the ejecting tube is collected and compressed by the contraction section, then enters the diffuser section through the throat, and diffuses through the diffuser section, enhancing the ejection effect, which not only reduces the heat loss, but also improves the heating efficiency. When the quantity of the ejecting tubes is more than one, the quantity of the corresponding nozzles is also more than one. The base body is provided with multiple gas inlet channels, and the gas inlet channels are selectively in communication with the nozzles. That is, one gas inlet channel is in communication with multiple nozzles or one nozzle, to achieve batch or individual control of the gas entry of the nozzles, thereby achieving batch or individual control of multiple ejecting tubes, to finally quickly adjust an output temperature.

### BRIEF DESCRIPTION OF THE DRAWINGS

FIG. 1 is a structural view of a housing in the present invention;

FIG. 2 is a structural view of the housing in the present invention from another angle of view;

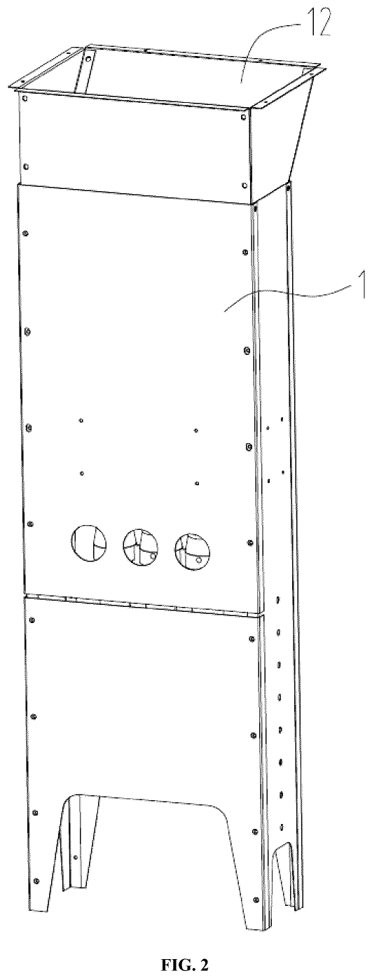

FIG. 3 is a top view of an entire structure in the present invention;

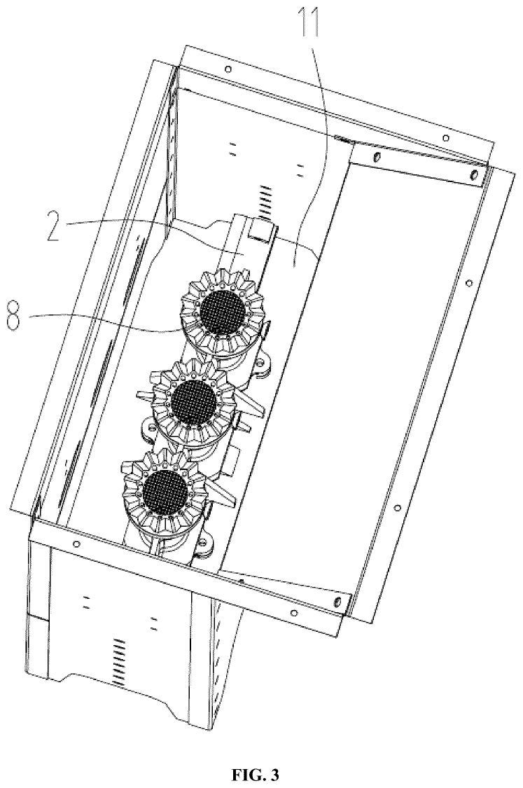

FIG. 4 is a structural view of an ejecting tube and a base body in the present invention;

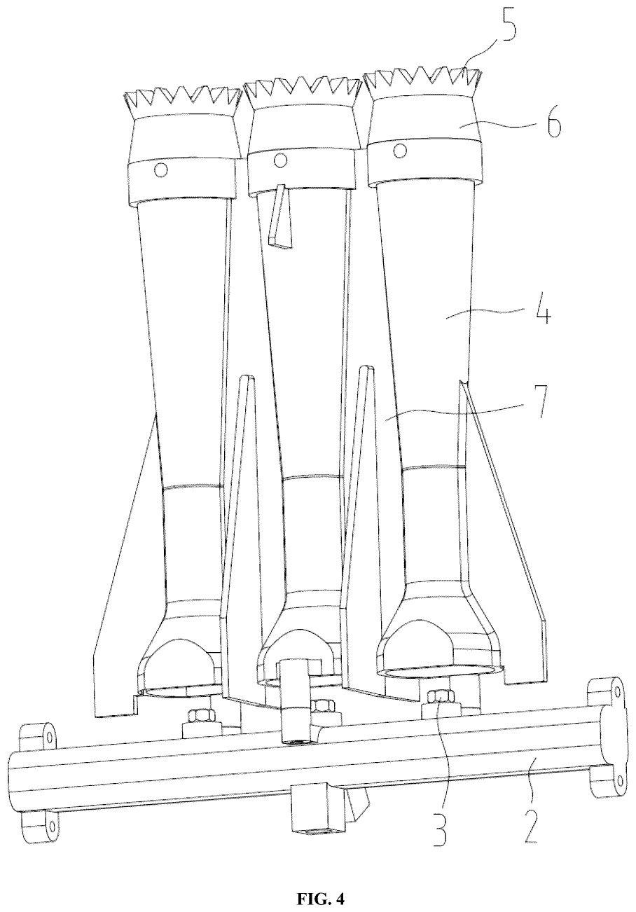

FIG. 5 is a structural view of the ejecting tube and the base body in the present invention from another angle of view;

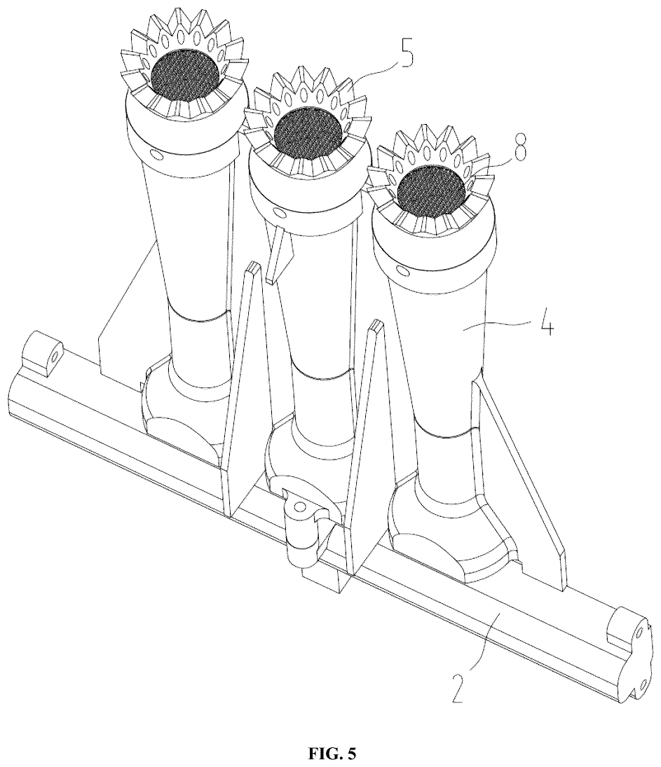

FIG. 6 is a transverse sectional view of the structure of the ejecting tube and the base body in the present invention;

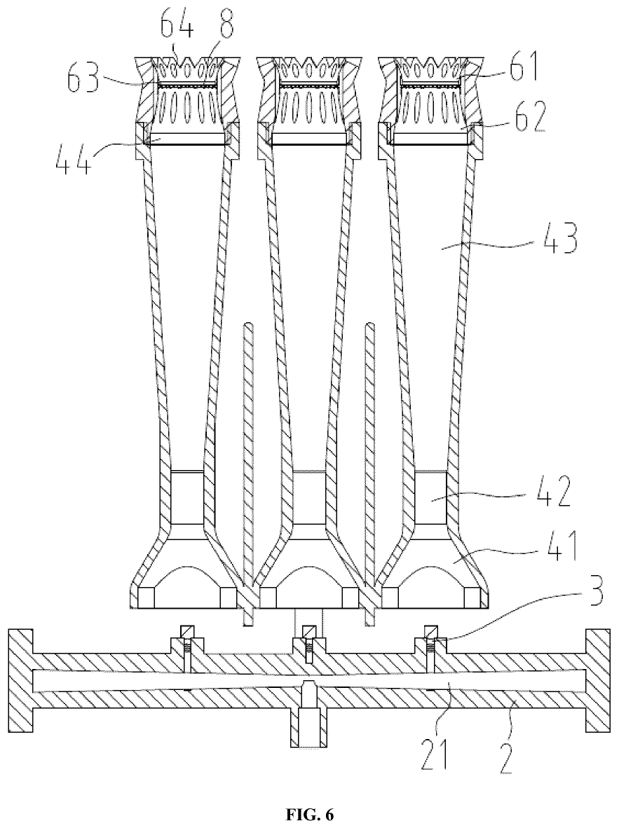

FIG. 7 is an exploded view of the structure of the ejecting tube and the base body in the

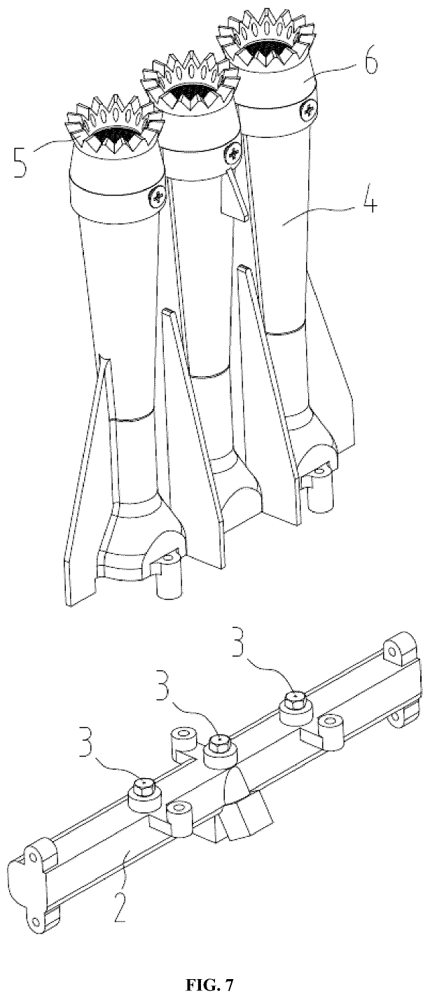

present invention;

FIG. 8 is a longitudinal sectional view of the structure of the ejecting tube and the base body in the present invention;

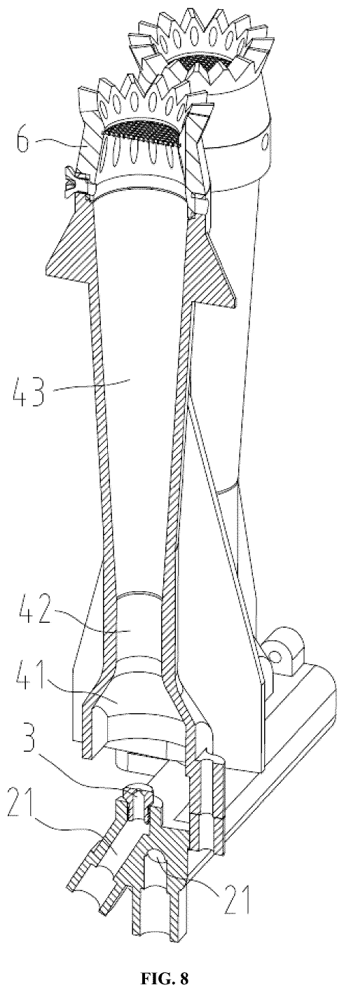

FIG. 9 is a longitudinal sectional view of the entire structure in the present invention; and

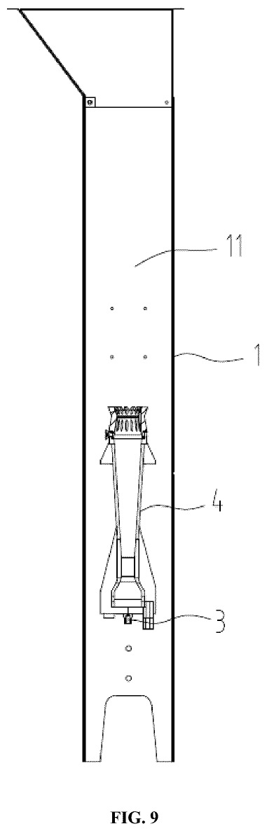

FIG. 10 is a sectional view of a structure of a through hole in the present invention.

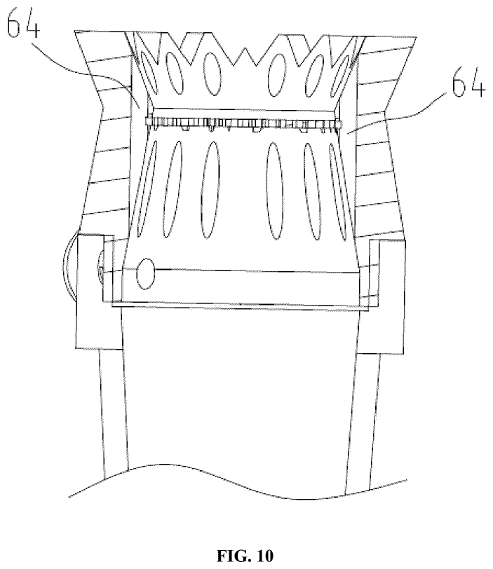

Reference numerals: 1. housing; 11. drainage cavity; 12. heat outlet; 2. base body; 21. gas inlet channel; 3. nozzle; 4. ejecting tube; 41. converging section; 42. transition section; 43. diverging section; 44. combustion port; 5. tooth-like structure; 6. flame projector; 61. diffuser section; 62. contraction section; 63. throat; 64. through hole; 7. reinforcing rib; and 8. mesh structure.

### DESCRIPTION OF THE EMBODIMENTS

The technical solutions in the embodiments of the present invention are clearly and completely described below with reference to the accompanying drawings in the embodiments of the present invention. Apparently, the embodiments described are merely some rather than all of the embodiments of the present invention. All other embodiments obtained by a person of ordinary skill in the art based on the embodiments of the present invention shall fall within the protection scope of the present invention.

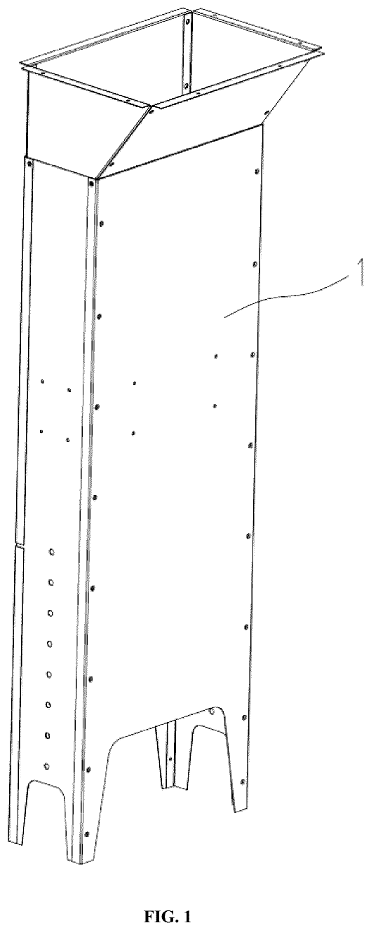

In this embodiment, as shown in FIG. 1, a heat flux barbecue burner includes a base body 2. The base body 2 is detachably mounted in a housing 1 through a fastener and provided with a nozzle 3. An ejecting tube 4 is vertically arranged above the nozzle 3 on the base body 2. An inner cavity of the ejecting tube 4 is in a rotator structure, that is, a cross section of an inner wall of the ejecting tube 4 is one or a combination of a circle, a cone, or a truncated cone.

A flame projector 6 is arranged at a top end of the ejecting tube 4. The inner cavity of the ejecting tube 4 sequentially includes a converging section 41, a transition section 42, and a diverging section 43 that are arranged coaxially from bottom to top. A diameter of the converging section 41 tapers from bottom to top, that is, the converging section 41 is in a truncated cone shape. The transition section 42 is a constant-diameter section, that is, the transition section 42 is in a cylindrical shape. A diameter of the diverging section 43 expands from bottom to top, that is, the diverging section 43 is in an inverted truncated cone shape. A length dimension of the diverging section 43 is greater than length dimensions of the transition section 42 and the converging section 41. In this embodiment, a length dimension ratio of the converging section 41 to the transition section 42 to the diverging section 43 is 1:2:4. A bottom end of the converging section 41 is a gas inlet. Gas ejected from the nozzle 3 enters from the bottom end of the converging section 41, and moves upward and sequentially passes through the converging section 41, the transition section 42, and the diverging section 43 to reach the flame projector 6 at a top end of the diverging section 43. The entire inner cavity of the ejecting tube 4 is in a rocket shape and has a smooth wall surface, thereby reducing the gas flow resistance and ensuring the ejection effect.

The bottom end of the converging section 41 further has a constant-diameter section, so that the gas coming out of the nozzle 3 can smoothly enter the converging section 41 along the constant-diameter section. The converging section 41 then tightens and converges the gas. The entire converging section 41 is in a conical cavity structure, so that the gas ejected by the nozzle flows to the diverging section 43 with the effect of converging first and then ejecting. A top end of the diverging section 43 is an opening, which is a combustion port 44.

Two ends of the flame projector 6 are open. An inner cavity of the flame projector 6 is also in a rotator structure and is formed by joining a diffuser section 61 and a contraction section 62. The diffuser section 61 and the contraction section 62 are distributed from top to bottom and a throat 63 is formed at a joint. A bottom end of the contraction section 62 is connected to the ejecting tube 4. A top end of the diffuser section 61 is provided with a circle of a tooth-shaped structure 5 evenly distributed. A mesh structure 8 is provided at the throat 63. An inner wall of the throat 63 is provided with an annular groove. An edge of the mesh structure 8 is embedded in the annular groove to be fixed.

The effect of the diffuser section 61 is the same as that of the diverging section 43, so that certain contraction can be formed after the gas enters the contraction section 62 from the diverging section 43. Then the gas enters the diffuser section 61 from the contraction section 62, so that the contracted gas can radiate into an ejector, allowing a large amount of gas to rush out quickly. The mesh structure 8 facilitates making the flame ejected by the flame projector 6 more stable and even.

Gaps between adjacent teeth in the tooth structure 5 are conducive to the mixing of high-temperature gas and air to form high-temperature gas with even temperature.

In this embodiment, both the diffuser section 61 and the contraction section 62 are truncated cone-shaped or cone-shaped rotators. A length dimension of the diffuser section 61 is less than a length dimension of the contraction section 62. A gradual slope of the contraction section 62 is less than a gradual slope of the diffuser section 61. That is, from a longitudinal section, an amplitude of an outward flaring of the diverging section 43 is greater than an amplitude of a downward flaring of the contraction section 62. An inner wall of the flame projector 6 is evenly provided with multiple through holes 64 circumferentially, and the multiple through holes 64 are arranged in an annular array. The through hole 64 penetrates downward to an inner wall of the contraction section 62 or two ports of the through hole 64 are respectively located on the inner wall of the contraction section 62 and an inner wall of the diffuser section 61. That is, the two ports of the through hole 64 are respectively elliptical on the inner walls of the diffuser section 61 and the contraction section 62. That is, a long axis direction of the elliptical port is consistent with an entire axial direction of the ejecting tube 4, so that the gas coming out of the ejecting tube 4 can partially pass through the through holes 64 to reach the ejector, to ensure that the high-temperature gas can be centrally supplied to the flame projector 6.

The flame projector 6 is detachably connected to the ejecting tube 4, the flame projector 6 is sleeved on the top end of the diverging section 43, and then the flame projector 6 is fixedly connected to the diverging section 43 peripherally by a fastener.

A quantity of the ejecting tubes 4 is two or more and the ejecting tubes 4 are arranged side by side. In this embodiment, the ejecting tubes 4 are sequentially arranged along a length direction of the base body 2 and connected to the base body 2, the nozzles 3 and the ejecting tubes 4 are arranged in one-to-one correspondence, and outer walls of adjacent ejecting tubes 4 are connected through reinforcing ribs 7 to enhance the stability of the entire ejecting tube 4.

Two gas inlet channels 21 are provided in the base body 2. When the gas inlet channels 21 are not in communication with each other, one nozzle 3 is in communication with one gas inlet channel 21 for the nozzle 3 to eject gas alone, and the other gas inlet channel 21 is in communication with at least one remaining nozzle 3 for the remaining nozzle 3 to eject gas. In this embodiment, a quantity of the gas inlet channels 21 is two, a quantity of the ejecting tubes 4 is three, and a quantity of the corresponding nozzles 3 is three, where one gas inlet channel 21 is in communication with two nozzles 3, so that the ejecting tubes 4 corresponding to the two nozzles 3 can simultaneously eject gas. The other gas inlet channel 21 alone is in communication with the remaining nozzle 3, so that the ejecting tube 4 corresponding to the nozzle 3 can eject gas alone. That is, batch or separate control of multiple ejecting tubes 4 can be achieved, thereby controlling an output temperature and quickly adjusting a required barbecue temperature.

Certainly, the two gas inlet channels 21 may be in communication with each other. In this case, the two gas inlet channels 21 are equivalent to one gas inlet channel, which is in communication with all the nozzles 3.

The present invention further includes a housing 1. In this embodiment, the housing 1 has a drainage cavity 11. An upper end of the housing 1 is provided with an opening in communication with the drainage cavity 11. The opening serves as a heat outlet 12, that is, a hot gas flow coming out of the ejecting tube 4 passes through the drainage cavity 11 of the housing 1 and then flows out of the heat outlet 12. The entire housing 1 is in a rectangular hollow structure. The base body 2 is fixedly connected to an inner wall at a central position of the housing 1. A top end of the ejecting tube 4 faces a port on the housing 1, so that the housing 1 can guide high-temperature gas generated by the ejector. Finally, the high-temperature gas comes out of the heat outlet 12 of the housing 1. The housing 1 is generally arranged vertically, and the ejecting tube 4 is also correspondingly arranged vertically. The housing 1 is laterally provided with a through hole for an external gas source to enter and then being connected to the gas inlet channel 21. In addition, the base body 2 and the ejecting tube 4 are generally located in a middle or lower part of the housing 1, so that a hot gas flow ejected by the flame projector 6 can flow to the heat outlet 12 along the drainage cavity 11, accelerating a drainage speed and an ejection force.

It should be noted that, the drainage cavity 11 of the housing 1 may be in a rectangular shape, or may be a cylindrical or conical shape, forming a channel-like cavity for converging and draining the hot gas flow ejected by the flame projector 6 to the heat outlet 12.

What is claimed is:

1. A heat flux barbecue burner, comprising:
a housing having a drainage cavity, wherein a heat outlet in communication with the drainage cavity is formed at a top of the housing;
a base body located in the drainage cavity of the housing and provided with a nozzle;
an ejecting tube located in the drainage cavity of the housing and arranged above the nozzle on the base body, wherein an inner cavity of the ejecting tube is in a rotator structure, and a combustion port is formed at a top end of the ejecting tube and faces the heat outlet of the housing; and
a flame projector arranged at the combustion port of the ejecting tube, wherein an inner cavity of the flame projector comprises a diffuser section distal to the ejecting tube and a contraction section proximal to the ejecting tube, the diffuser section expands from one end proximal to the ejecting tube to the other end distal to the ejecting tube, so that a diameter of the end of the diffuser section proximal to the ejecting tube is less than a diameter of the other end distal to the ejecting tube, and the contraction section expands from one end proximal to the diffuser section to the other end distal to the diffuser section, so that a diameter of the end of the contraction section proximal to the diffuser section is less than a diameter of the other end distal to the diffuser section.

2. The heat flux barbecue burner according to claim 1, wherein the inner cavity of the ejecting tube comprises a converging section proximal to the nozzle and a diverging section distal to the nozzle, the converging section tapers from one end proximal to the nozzle to the other end distal to the nozzle, so that a diameter of the end of the converging section proximal to the nozzle is greater than a diameter of the other end distal to the nozzle, the diverging section expands from one end proximal to the converging section to the other end distal to the converging section, so that a diameter of the end of the diverging section proximal to the converging section is less than a diameter of the other end distal to the converging section, and a combustion port is formed at a top end of the diverging section and faces the heat outlet of the housing.

3. The heat flux barbecue burner according to claim 2, wherein the inner cavity of the ejecting tube further comprises a transition section, the transition section is located between the converging section and the diverging section, and the transition section, the converging section, and the diverging section are in communication with each other.

4. The heat flux barbecue burner according to claim 3, wherein the transition section is a constant-diameter section.

5. The heat flux barbecue burner according to claim 2, wherein the flame projector is provided with a tooth-like structure, a flaming port, and a connection port, the flaming port is located at a large-diameter end of the diffuser section, the tooth-like structure is evenly distributed along a circle of the flaming port, and the connection port is located at a large-diameter end of the contraction section and connected to a port at the other end of the diverging section.

6. The heat flux barbecue burner according to claim 5, wherein a throat is formed at a joint between the diffuser section and the contraction section, a mesh structure is provided at the throat, and a diameter of the throat is less than a diameter of the other end of the diffuser section distal to the diverging section and the diameter of the end of the contraction section proximal to the diffuser section.

7. The heat flux barbecue burner according to claim 6, wherein an inner wall of the flame projector is provided with multiple through holes, the multiple through holes are arranged in an annular array, and two ends of each through hole are located on an inner wall of the contraction section and an inner wall of the diffuser section respectively.

8. The heat flux barbecue burner according to claim 7, wherein a length dimension of the diffuser section is less than a length dimension of the contraction section, and a gradual slope of the contraction section is less than a gradual slope of the diffuser section.

9. The heat flux barbecue burner according to claim 1, wherein a quantity of the ejecting tubes is two or more, the two or more ejecting tubes are arranged side by side, a quantity of the nozzles is equal to the quantity of the ejecting tubes, and positions of the nozzles correspond to positions of the two or more ejecting tubes respectively.

10. The heat flux barbecue burner according to claim 9, wherein the base body is provided with two gas inlet channels, and when the two gas inlet channels are not in communication with each other, one nozzle is in communication with one gas inlet channel for the nozzle to eject gas alone, and the other gas inlet channel is in communication with at least one remaining nozzle for the remaining nozzle to eject gas.
